(19) United States
(12) Patent Application Publication
(10) Pub. No.: US 2013/0022344 A1
(43) Pub. Date: Jan. 24, 2013

(54) 3-DIMENSIONAL PHOTOGRAPHING LENS SYSTEM AND PHOTOGRAPHING DEVICE HAVING THE SAME

(71) Applicant: Jae-Cheol BAE, Suwon-si (KR)

(72) Inventor: Jae-Cheol BAE, Suwon-si (KR)

(73) Assignee: Samsung Electronics Co., Ltd.

(21) Appl. No.: 13/552,295

(22) Filed: Jul. 18, 2012

(30) Foreign Application Priority Data
Jul. 20, 2011 (KR) 10-2011-0072178

(51) Int. Cl. G03B 35/00

(52) U.S. Cl. 396/324

(57) ABSTRACT

Disclosed is a 3-dimensional lens system adapted to reduce aberrations occurring as a left-eye image passing through a left-eye lens group and a right-eye image passing through a right-eye lens group are off-axially incident to the left-eye lens group and the right-eye lens group, respectively, and that is fabricated in a reduced size without using a reflection mirror. Also disclosed is an image capture device designed to be larger than an image so as to prevent a loss of the image.

### PRIORITY

This application claims priority under 35 U.S.C. §119(a) to an application filed in the Korean Industrial Property Office on Jul. 20, 2011 and assigned Serial No. 10-2011-0072178, the contents of which are incorporated herein by reference.

### BACKGROUND OF THE INVENTION

1. Field of the Invention

The present invention relates generally to a 3-dimensional photographing lens system and a photographing apparatus having the same, and more particularly, to a 3-dimensional photographing lens system with a left-eye lens group and a right-eye lens group, and a photographing apparatus having the lens system.

2. Description of the Related Art

There has recently been a significant increase in the demand for digital cameras and video cameras, which are provided with a solid image capture device, such as a CCD (Charge Coupled Device) or a CMOS (Complementary Metal-Oxide Semiconductor). In addition, digital cameras that employ an image sensor, such as a solid image capture device (CCD or CMOS), and store images using a memory, have become more popular than film cameras.

Digital cameras have become more and more sophisticated due to the high standards expected by users and technical progress, and lenses with various levels of performance have been developed. For example, there has been an increase in the demand for lens systems that can 3-dimensionally photograph an object.

When photographing a moving object, a time-division type 3-dimensional photographing lens system, which captures a left-eye image and a right-eye image sequentially in time, exhibits a difference in time (delay) between the left-eye and right-eye images, causing a vertical deviation for the moving object. The human eye very sensibly responds to the vertical deviation caused by the 3-dimensional photographing lens system, which causes eye fatigue. In addition, the vertical deviation is increased due to errors in assembling left and right reflection mirrors.

When the reflection mirrors are employed, a horizontal size of an image increases, making it difficult to miniaturize the 3-dimensional photographing lens system. When the reflection mirrors are not employed, the 3-dimensional photographing lens system includes a left-eye lens system and a right-eye lens system, in which a plurality of convex lenses are positioned between the left-eye and right-eye lens systems and an image capture device on which images fall. The convex lenses reduce an image falling extent, thereby enabling the reduction of the size of the 3-dimensional photographing lens system.

When the convex lenses are employed in the 3-dimensional photographing lens system, left-eye and right eye images are excessively focused through the convex lenses, causing increased aberration. Because aberration appears as distortion on each of the left-eye and right-eye images, the aberration may have an influence on the reproduction of a 3-dimensional image. In order to obtain a fine 3-dimensional image through the 3-dimensional photographing lens system, aberration must be reduced.

In a photographing apparatus employing two image capture devices, on which left-eye and right-eye images fall, respectively, if the image capture devices are equal in size to the left-eye image and the right-eye image, respectively, or no extra space is provided in the image capture devices, the left-eye and right-eye images is partially lost. In order to obtain a fine 3-dimensional image through the photographing apparatus having the 3-dimensional photographing lens system, it is necessary to prevent the loss of the left-eye-and right-eye images.

### SUMMARY OF THE INVENTION

An aspect of the present invention is to solve the above-mentioned problems and to provide a 3-dimensional photographing lens system capable of reducing aberrations and having a reduced size by not employing a reflection mirror.

Another aspect of the present invention is to provide an image capture device designed to be larger than images falling thereon in order to prevent the loss of the images.

In accordance with an aspect of the present invention, there is provided a 3-dimensional photographing lens system, including, in order from an object side to an image side, a first lens group including a left-eye lens group with negative refractive power and a right-eye lens group with negative refractive power, the left eye lens group and the right-eye lens group being spaced apart from an optical axis left and right by a distance in parallel to the optical axis, a second lens group with positive refractive power, the second lens group including at least one convex lens, and a third lens group with negative refractive power, the third lens group including at least one concave lens, the 3-dimensional photographing lens system satisfying:

1.25<f₂/f₃<3.5

wherein f₂ is the focal length of the second lens group, and f₃ is the focal length of the third lens group.

In accordance with another aspect of the present invention, there is provided a photographing apparatus including, in order from an object side to an image side, a first lens group including a left-eye lens group with negative refractive power and a right-eye lens group with negative refractive power, the left eye lens group and the right-eye lens group being spaced apart from an optical axis left and right by a distance in parallel to the optical axis, a second lens group with positive refractive power, the second lens group including at least one convex lens, a third lens group with negative refractive power, the third lens group including at least one concave lens, and an image capture device for receiving an image which has passed through the lens groups.

In accordance with another aspect of the present invention, there is provided a photographing apparatus, including a 3-dimensional photographing lens system, and an image capture device for receiving an image captured by the 3-dimensional photographing lens system, wherein the image capture device is divided into a left-eye image falling region and a right-eye image falling region.

In accordance with another aspect of the present invention, there is provided a photographing apparatus, including a 3-dimensional photographing lens system, and an image capture device for receiving an image captured by the 3-dimensional photographing lens system.

In accordance with another aspect of the present invention, there is provided a 3-dimensional photographing lens system, including a left-eye lens group and a right eye-lens group which are spaced apart from an optical axis by a distance in different directions, each of the left-eye and right-eye lens groups having at least one negative lens, at least one positive lens positioned between the left-eye and right-eye lens groups and an iris, and at least one negative lens positioned between the positive lens and the iris.

In accordance with another aspect of the present invention, there is provided a 3-dimensional photographing lens system, including, in order from an object side to an image side, a left-eye lens group and a right eye-lens group which are spaced apart from an optical axis left and right by a distance in parallel to the optical axis, each of the left-eye and right-eye lens groups having at least one negative lens, at least one convex lens positioned between the left-eye and right-eye lens groups and an iris, at least one concave lens positioned between the positive lens and the iris; and at least one convex lens between the iris and the image side, the convex lens being movable along the optical axis depending on the position of a to-be photographed object to correct focus.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a 3-dimensional photographing lens system in accordance with a first embodiment of the present invention;

FIGS. 2A and 2B illustrate spherical aberration and astigmatic aberration data for the 3-dimensional photographing lens system in accordance with the first embodiment;

FIG. 3 illustrates distortion data of the 3-dimensional photographing lens system in accordance with the first embodiment;

FIG. 4 illustrates a 3-dimensional photographing lens system in accordance with a second embodiment;

FIGS. 5A and 5B illustrate spherical aberration and astigmatic aberration data for the 3-dimensional photographing lens system in accordance with the second embodiment;

FIG. 6 illustrates distortion data of the 3-dimensional photographing lens system in accordance with the second embodiment;

FIG. 7 illustrates a 3-dimensional photographing lens system in accordance with a third embodiment;

FIGS. 8A and 8B illustrate spherical aberration and astigmatic aberration data for the 3-dimensional photographing lens system in accordance with the third embodiment;

FIG. 9 illustrates distortion data of the 3-dimensional photographing lens system in accordance with the third embodiment;

FIG. 10 illustrates an image capture device in accordance with yet another embodiment of the present invention;

FIG. 11 illustrates images falling on a conventional image capture device by way of an example;

FIG. 12 illustrates images falling on the inventive image capture device by way of an example; and

FIG. 13 illustrates a photographing apparatus having a 3-dimensional photographing lens system in accordance with still another embodiment of the present invention.

### DETAILED DESCRIPTION OF EMBODIMENTS OF THE PRESENT INVENTION

Hereinafter, embodiments of the present invention will be described with reference to the accompanying drawings. In the following description, the same elements will be designated by the same reference numerals although they are shown in different drawings. In the drawings, the thickness and sizes of components may be exaggeratedly expressed for convenience of description. Further, a detailed description of known functions and configurations incorporated herein will be omitted for the sake of clarity and conciseness.

Although numerical values are presented in this description, the scope of the present invention is not limited thereto.

The inventive 3-dimensional photographing lens system is employed in a video camera and a film camera, in which the lens system is configured to be variable or not in its entire length at the time of focusing in order to improve the portability.

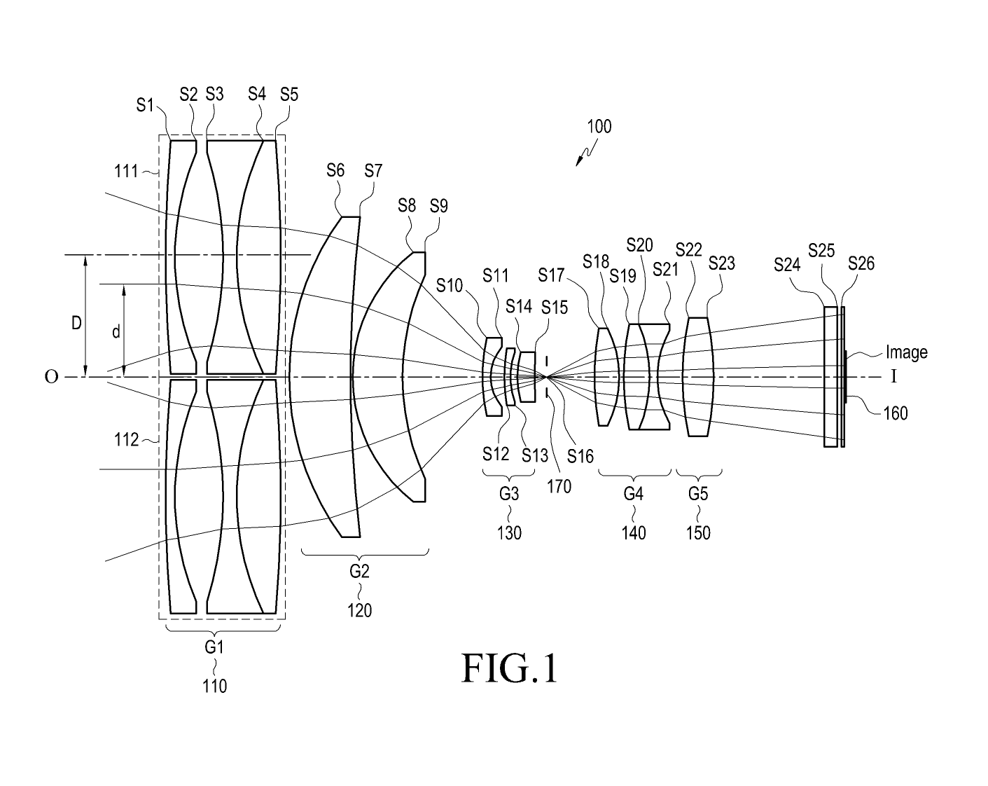

FIG. 1 illustrates a 3-dimensional photographing lens system in accordance with a first embodiment of the present invention.

Referring to FIG. 1, the inventive 3-dimensional photographing lens system 100 may include, in order from an object side O to an image side I, a first lens group G1, 110 having negative refractive power, a second lens group G2, 120 having positive refractive power, a third lens group G3, 130 having negative refractive power, a fourth lens group with positive refractive power G4, 140, and a fifth lens group G5, 150 having positive refractive power.

In addition, the 3-dimensional photographing lens system 100 may include an iris 170 between the third lens group 130 and the fourth lens group 140.

It is possible to tune the amount of beams falling on an image capture device 160 by tuning the size of the iris 170.

The lenses are classified into plural groups as described above by dividing the lenses into two or more groups, each of which either conducts a function different from those of other lens groups, or has a different arrangement of lenses as compared to those of other groups. In addition, it is also possible to classify the lenses into plural groups by binding neighboring lenses to form the plural groups.

Under the concave lens principle, if parallel beams are incident to a lens group with negative refractive power, the beams diverge from each other as they pass through the lens group.

Whereas, under the convex lens principle, if parallel beams are incident to a lens group with positive refractive power, the beams converge as they pass through the lens group.

The first lens group 110 may include a left-eye lens group 111 and a right-eye lens group 112, and each of a left-eye lens group 111 and a right-eye lens group 112 includes a meniscus lens with negative refractive lens and a cemented lens having a concave lens with negative refractive power and a convex lens with positive refractive power.

The left-eye lens group 111 and the right-eye lens group 112 are spaced apart from an optical axis left and right by a distance D in parallel to the optical axis, so that an inter-camera distance 2d is produced between the left-eye image and the right-eye image. The optical axis is indicated by the line O-I in FIG. 1. The optical axis is an imaginary line that passes through the center of the 3-dimensional photographing lens system 100, and the optical axis coincides with an axis of rotational symmetry about either a central portion or the entire 3-dimensional photographing lens system 100.

The left-eye image passes through the left-eye lens group 111, and the right-eye image passes through the right-eye lens group 112, so that the images fall on the image capture device 160.

The left-eye lens group 111 may include at least one of a convex lens with positive refractive power, a concave lens with negative refractive power, and a cemented lens.

The cemented lens is a lens formed by a concave lens and a convex lens arranged to be in surface-to-surface contact with each other, and cemented on the contacted surfaces.

The left-eye lens group 111 consists of the meniscus lens and the cemented lens in such a manner that the entire focal length thereof exhibits that of a concave lens with negative refractive power.

By reducing the number of lenses in the left-eye lens group 111, it is possible to reduce a deviation between a left-eye image and a right-eye image, which is caused while the lenses are being manufactured and assembled.

In order to correct the chromatic aberration of the left-eye lens group, the concave lens and the convex lens is formed from different materials, such that the correction extent of the chromatic aberration is varied.

Each of the materials has an inherent Abbe number (vd) at the d-line (587.5618 nm).

Depending on the different materials, the ratio of Abbe numbers is varied, and depending on the ratio, the correction extent of the chromatic aberration is varied. That is, by properly using a material with a lower Abbe number (dispersion value) for one of the convex lens and the concave lens, and a material with a higher Abbe number for the other, it is possible to minimize the chromatic aberration of the cemented lens.

The right-eye lens group 112 is positioned opposite to the left-eye lens group 111 with reference to the optical axis, is spaced apart from the optical axis by a distance, is different from the left-eye lens group 111 only in position, and has the same properties with the left-eye lens group 111.

A left-eye image that has passed through the left-eye lens group 111 and a right-eye image that has passed the right-eye lens group 112 may fall on the image capture device 160 at different regions without a difference in time.

Unlike a 3-dimensional photographing lens system employing a reflection mirror, the 3-dimensional photographing lens system 100 collecting the left-eye image and the right-eye image at once through the image capture device 160 does not cause a difference in time (delay) between left-eye and right-eye images when photographing a moving image, and exhibits slight vertical deviation for the movement of an object in the vertical direction, thereby effectively reducing and/or preventing eye fatigue while viewing the left-eye and right-eye images.

Depending on the construction of the 3-dimensional photographing lens system 100, the distance between the left-eye lens group 111 and the right-eye lens group 112 is varied.

The vertical direction indicates a direction vertical to an imaginary straight line extending through the left-eye lens group 111 and the right-eye lens group 112. That is, the vertical direction is perpendicular to the optical axis.

The second lens group 120 is positioned on the optical axis, and may include one or more convex lenses.

Because the second lens group 120 can reduce the widths of the images that have passed through the left-eye lens group 111 and the right-eye lens group 112 of the first lens group 100, thereby reducing the sizes of the images, it is possible to miniaturize the lens groups positioned between the second lens group 120 and the image capture device 160.

In order to use a single iris 170 for the reduced left-eye and right-eye lenses, the iris 170 is positioned between the second lens group 120 and the image capture device 160.

By providing the single iris 170, the unconformity of the left-eye and right-eye images passing through the iris 170 is reduced in terms of deviation from the optical axis.

Because the second lens group 120 includes plural meniscus-shaped convex lenses, the sizes of the images are reduced without substantially producing an astigmatic aberration.

For example, if a single meniscus-shaped convex lens is used in the second lens group 120, it is necessary to increase the curvature of the meniscus-shaped convex lens to be more than those of two or more convex lenses in order to reduce the sizes of the images, which substantially increases an asymmetry of tangential and sagittal curvatures at an off-axis position of the lenses, thereby substantially increasing the astigmatic aberration.

Because the image (i.e., the light forming the image) that have passed through the first lens group 110 are incident to the second lens group 120 off-axially, the astigmatic aberration is increased if the asymmetry of the curvatures is increased.

The third lens group 130 is positioned on the optical axis, and may include two concave lenses and one convex lens.

In the sense of order of lenses from the object side to the image side, the first lens in the third lens group 130 is a concave lens, by which the astigmatic aberration occurring in the second lens group 120 are corrected. Because the left-eye lens group 111 and the right-eye lens group 112 in the first lens group 110 are spaced apart from each other, the left-eye image and the right-eye image are off-axially incident to the second lens group 120.

The astigmatic aberration of the off-axially incident left-eye and right-eye images are produced due to the asymmetry of the tangential and sagittal curvatures of the second lens group 120.

The astigmatic aberration produced due to the convex lenses of the second lens group 120 is corrected by tuning the curvature of the convex lens of the third lens group 130.

As to order of lenses from the object side to the image side, a concave lens is positioned in the object side and a convex lens is positioned in the image side in the third lens group 130.

With the convex lens positioned in the image side, the sizes of the let-eye image and the right-eye image incident to the iris are reduced.

The astigmatic aberration occurring in the second lens group 120 is reduced by the concave lens. In addition, by using another concave lens different from the above-mentioned concave lens, the astigmatic aberration occurring in the second lens group 120 is also reduced.

Therefore, in accordance with the present invention, a favorable correction and maintenance of balance in astigmatic aberration is achieved when the requirements of Equation (1) and Equation (2) are satisfied.

$$0.5 < \vert \frac{{f}_{3}}{f} \vert < 2.0 \qquad ( 1 )$$

In Equation (1), f is the focal length of the entire lens system when the lens system is focused on an object at an infinite distance, and f₃ is the focal length of the third lens group 130. That is, the focal length is the distance over which initially collimated light is brought to a focus.

$$1.25 < \vert \frac{{f}_{2}}{{f}_{3}} \vert < 3.5 \qquad ( 2 )$$

Herein, f₂ is the focal length of the second lens group 120, and f₃ is the focal length of the third lens group 130.

Equation (1) expresses a ratio of the focal length of the third lens group 130 in relation to the entire focal distance, in which Equation (1) shows that the local length of the third lens group 130 is relatively short, i.e. the refractive power of the third lens group 130 is relatively high.

Equation (2) expresses a ratio of the focal length of the second lens group 120 in relation to the focal length of the third lens group 130.

If the third lens group 130 satisfies the requirements of Equation (1) and Equation (2), the astigmatic aberration occurring in the lens system is corrected, so that the entire length of the lens system is properly maintained.

If the lens system satisfies Equation (2) but exceeds the upper limit of Equation 1, and hence the refractive power of the third lens group 130 becomes low, the astigmatic aberration is corrected since the balance in astigmatic aberration is maintained. However, the spherical aberration and coma aberration occurring in the third lens group 130 are not corrected, and the entire length of the lens system will be increased, causing an increase of the diameters of the lenses.

If the lens system is out of the upper and lower limits of Equation (2), the balance in astigmatic aberration of the second lens group 120 and the third lens group 130 cannot be maintained, thereby hindering performance of the lens system.

In order to reduce the widths of images, which have passed through the first lens group 110, by the second lens group 120, and in order to maintain the balance of astigmatic aberration occurring in the second lens group 110, it is necessary to maintain a spacing between the second lens group 120 and the third lens group 130.

For example, depending on the refractive power of a lens at the time of fabrication, the size of the lens is limited.

In order to correct the astigmatic aberration, the third lens group 130 is formed to satisfy the requirements of Equation (1) and Equation (2), by which the refractive power of the third lens group 130 is determined.

If the refractive power is determined, the entire focal length including the first lens group 110 to the third lens group 130 is determined.

If the spacing between the second lens group 120 and the third lens group 130 is reduced when the focal length is determined, the size of the third lens group 130 will be increased.

If the second lens group 120 and the third lens group 130 are spaced apart from each other, the size of an image incident to the third lens group 130 after passing through the second lens group 120 will be reduced.

As such, it is possible to fabricate the third lens group 130 in a size for easy fabrication, i.e. in a size with a reduced diameter.

The fourth lens group 140 is positioned on the optical axis, and may include a convex lens and a cemented lens. The cemented lens includes a convex lens and a concave lens. By forming the cemented lens with a lens having a low dispersion value and a lens having a high dispersion value, it is possible to remove the chromatic aberrations of an image which has passed through the third lens group 130.

The convex lens in the fourth lens group 140 is formed aspherically, thereby minimizing the spherical aberration of an image incident to the fourth lens group 140 through the third lens group 130.

Upon satisfying the requirement of Equation (3) below, the fourth lens group 140 can favorably correct the spherical aberration and a coma aberration, as well as an astigmatic aberration remaining from the second lens group 120 and the third lens group 130, and can prevent the lens system from becoming larger.

$$0.7 < \vert \frac{{f}_{4}}{f} \vert < 2.5 \qquad ( 3 )$$

Herein, f is the focal length of the entire lens system when the lens system is focused on an object at an infinite distance, and f₄ is the focal length of the fourth lens group 140.

Equation (3) expresses a ratio of the focal length f₄ in relation to the focal length f of the entire lens system, in which Equation (3) indicates that the focal length of the fourth lens group 140 is relatively short, i.e., the refractive power of the fourth lens group 140 is relatively high.

Upon satisfying the requirement of Equation (3), the fourth lens group 140 can favorably correct the spherical aberration, coma aberration and astigmatic aberration occurring in the third lens group 130, which makes it possible to properly maintain the entire length of the lens system.

If the fourth lens group 140 exceeds the upper limit of Equation (3) and hence its refractive power becomes low, the aberrations and balance in aberration occurring in the third lens group are not maintainable, making it exceedingly difficult to favorably correct the spherical aberration, coma aberration and astigmatic aberration.

In addition, because the entire length of the lens system is increased, the diameters of the lenses are larger.

If the fourth lens group 140 is below the lower limit, and hence its refractive power becomes high, it will be difficult to maintain the balance in aberration of the third lens group 130, and the spherical aberration will be substantially increased, making it exceedingly difficult to implement a properly performing lens system.

If the lens system satisfies the requirement of Equation (2) but is below the lower limit, and hence the refractive power of the fourth lens group 140 is low, it will be difficult to maintain the balance in aberration of the fourth lens group 140 and the spherical aberration will be increased, making it exceedingly difficult to implement a properly performing 3-dimensional photographing lens system 100, although the astigmatic aberration is favorably corrected since the balance in astigmatic aberration is maintained.

The fifth lens group 150 is positioned on the optical axis and includes a convex lens, in which the fifth lens group 150 is movable along the optical axis at the time of focusing an image on the image capture device 160.

In order to prevent the length of the 3-dimensional photographing lens system 100 from being increased, the fifth lens group 150 is formed by a single lens group rather than by plural sub-groups. With the single lens group, the sub-groups are not independently movable from each other.

Upon being formed by the single lens group, the fifth lens group 150 has a light weight, thereby reducing the size of a motor responsible for moving the fifth lens group 150 and simplifying the circuits thereof.

The fifth lens group 150 includes one convex lens, of which both sides are convex.

Through the movement for focusing an image falling on the image capture device 160, the fifth lens group 150 can correct the distortion aberration and the curvature of image field of an image that has passed through the fourth lens group 140.

By conducting the focusing of the left-eye and right-eye images by the one lens of the fifth lens group 150, it is unnecessary to individually conduct the focusing operations of a left-eye image and a right-eye image to be cooperated with each other, thereby simplifying the installation and circuit constructions in this connection.

In order to conduct the focusing for allowing an image to fall on the image capture device 160, at least one of the first to fifth lens groups 110, 120, 130, 140 and 150 of the 3-dimensional photographing lens system 100 is adapted to be movable.

Even if the at least one lens group is adapted to be movable, the length of the 3-dimensional photographing lens system, i.e., the length from the first lens group 110 to the image capture device 160 may not be changed.

The size of an image falling on the image capture device 160 is varied in accordance with the entire focal length of the 3-dimensional photographing lens system 100 and the arrangement of the lenses.

The iris 170 is positioned on the optical axis, and is positioned between the third lens group 130 and the fourth lens group 140.

The iris 170 is employed as a light amount adjusting means, and is used commonly for the left-eye image and the right-eye image in order to prevent the light amount adjusting means from being deviated with reference to the optical axis.

The position of the iris 170 is changed depending on the design of the 3-dimensional photographing lens system 100.

The 3-dimensional photographing lens system 100 may include a hand-shake correction group.

For example, at least one lens group among the second lens group 120 to fifth lens group 150 is used as the hand-shake correction group, which moves vertically in relation to the optical axis to correct the hand-shake. In order to reduce the movement of the hand-shake correction group, the focal length of the hand-shake correction group is reduced.

It is noted that such a hand-shake correction method can be readily changed by a person ordinarily skilled in the art.

If the movement of the hand-shake correction group is small, the size of the 3-dimensional photographing lens system 100 is decreased.

For example, due to the positive refractive power of the second lens group 120, an image converges to the third lens group 130, which allows the aperture of the third lens group 130 to be reduced. Therefore, when the third lens group 130 is used as the hand-shake group, the weight of the 3-dimensional photographing lens system is reduced. Alternatively, a fixed lens group rather than a movable lens group is used as the hand-shake correction group, which is advantageous for the designing and electronic control of an instrument for moving the hand-shake correction group.

For example, the fourth lens group 140 may include the hand-shake correction group. In addition, some of the lenses of the second lens group 120 or some of the lenses of the fifth group 150 are movable vertically to conduct the hand-shake correction. However, the present invention is not limited to this, and all of the lenses of the second lens group 120 or the fifth lens group 150 are movable to correct the hand-shake.

The 3-dimensional photographing lens system 100 in accordance with the present embodiment may have a small F-number, and hence may have an improved resolution and an increased amount of light. The refractive power of the lens system is distributed to the individual lens groups, which have a small F-number due to the small number of lenses, and a field of view of the first lens group 110 is large. As a result, a light-weight 3-dimensional photographing lens system 100 is provided.

The present invention implements various lens systems through plural embodiments according to various designs as follows. Hereinbelow, f indicates the entire focal length, and 2ω indicates a field of view, in which a filter is provided at the top side (O) of each of FIGS. 1, 4 and 7 showing different embodiments.

### First Embodiment

FIG. 1 is depicted in accordance with the lens data of the first embodiment.

S1 to S23 indicate relevant lens surfaces, respectively, and S24 to S26 indicate relevant plates, respectively.

f=14.734, 2ω=41.5 degrees, and F-number=5.15

Table 1 shows numerical data of components constituting the 3-dimensional photographing lens system 100. In the numerical data, R denotes the radius of curvature of an i^{th} lens surface Si, D denotes the thickness of the i^{th} lens surface Si or an air gap (or a distance) between the i^{th} lens surface Si and an (i+1)^{th} lens surface S(i+1), Nd denotes a refractive index at the d-line (587.5618 nm) of the i^{th} lens surface Si, and vd denotes an Abbe number of the i^{th} lens surface Si, wherein a unit of the radius of curvature and the thickness is mm.

TABLE 1

| | R (Curvature Radius | D (Thick- | Nd (Refractive | νd |
|---|---|---|---|---|
| Object | of Lens Surface) | ness) | Index) | (Abbe No.) |
| S1 | 300.000 | 1.500 | 1.83868 | 30.80 |
| S2 | 49.124 | 8.597 | | |
| S3 | −63.262 | 2.500 | 1.80420 | 46.50 |
| S4 | 50.601 | 7.969 | 1.84666 | 23.78 |
| S5 | −169.363 | 1.353 | | |
| S6 | 47.932 | 11.000 | 1.78590 | 43.93 |
| S7 | 221.042 | 0.300 | | |
| S8 | 28.000 | 8.773 | 1.74106 | 43.80 |
| S9 | 41.949 | 14.422 | | |
| S10 | 38.909 | 1.317 | 1.84666 | 23.78 |
| S11 | 7.760 | 2.483 | | |
| S12 | 40.198 | 1.000 | 1.65033 | 33.26 |
| S13 | 14.836 | 1.176 | | |
| S14 | 18.792 | 3.274 | 1.83481 | 42.72 |
| S15 | 72.334 | 2.778 | | |
| S16 | ST | 7.968 | | |
| S17 | 75.091 | 4.321 | 1.77079 | 47.94 |
| S18 | −17.121 | 0.800 | | |
| S19 | 45.846 | 4.398 | 1.80400 | 46.50 |
| S20 | −23.718 | 1.500 | 1.69284 | 30.09 |
| S21 | 18.976 | 4.570 | | |
| S22 | 57.556 | 5.500 | 1.49700 | 81.61 |
| S23 | −45.333 | 19.876 | | |
| S24 | Infinity | 2.240 | 1.51680 | 64.20 |
| S25 | Infinity | 0.500 | | |
| S26 | Infinity | 0.700 | 1.51680 | 64.20 |
| Image | Infinity | 0.400 | | |

Coefficients of aspheric surfaces formed on S17 and S18 are indicated in Table 2.

TABLE 2

| Object | K | A | B | C |
|---|---|---|---|---|
| S17 | 0.340 | 9.662926E−07 | 1.497559E−07 | −1.000883E−11 |
| S18 | −0.353 | 2.323885E−05 | 1.447206E−07 | 1.040018E−09 |

The definition for the aspheric coefficients applied to the fourth lens group 140 in accordance with the present embodiment was equally applied to the first, second and third embodiments.

Assuming that the direction of the optical axis is an x-axis, and the progress direction of an image is positive, an aspheric shape is expressed as Equation (4). In Equation (4), x indicates a distance from the apex of a lens in the direction of the optical axis, y indicates a distance vertical to the optical axis, K indicates a conic constant, A, B, C and D indicate aspheric coefficients, respectively, and c′ indicates a reciprocal (1/R) of the curvature radius at the apex of the lens.

$$x = \frac{{c}^{′} {y}^{2}}{1 + \sqrt{1 - ( K + 1 ) {{c}^{′}}^{2} {y}^{2}}} + {Ay}^{4} + {By}^{6} + {Cy}^{8} + {Dy}^{10} \qquad ( 4 )$$

Herein, x is a distance from the apex of a lens in the direction of the optical axis, y is a distance vertical to the optical axis, c′ is a reciprocal (1/R) of the curvature radius at the apex of the lens, K is a conic constant, and A, B, C and D are aspheric coefficients.

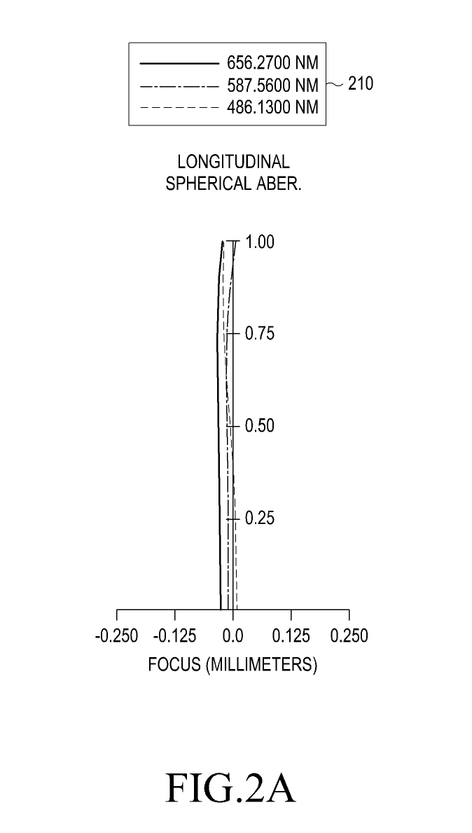

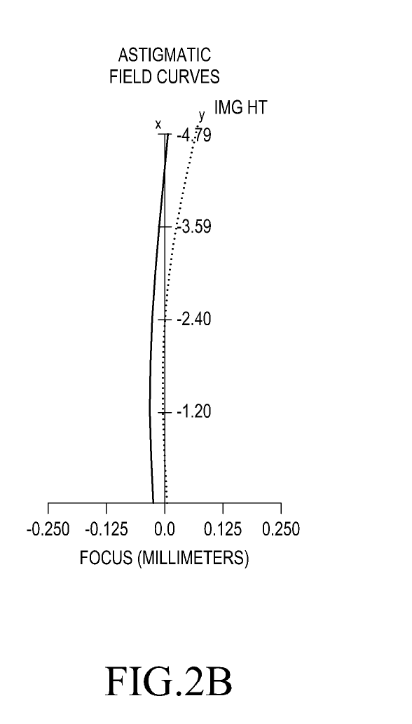

FIG. 2A illustrates a change in longitudinal spherical aberration of the lens system in accordance with the first embodiment. As shown, the longitudinal spherical aberration data is variable as a wavelength is changed.

In FIG. 2A, the horizontal axis indicates longitudinal spherical aberration coefficient, and the vertical axis indicates normalized distance from the optical axis to an edge of an image. That is, the horizontal axis represents the deviation in mm units of the position of the focal point, and the vertical axis represents an incidence height of light normalized by the maximum incidence height.

In FIG. 2A, even if the wavelength is changed as indicated in a box 210, there is a small change in longitudinal spherical aberration. From this, it is concluded that the longitudinal spherical aberration occurs slightly in the 3-dimensional photographing lens system (100) of FIG. 1.

FIG. 2B illustrates a change in astigmatic aberration and curvature of image field, in which the results in the drawing are obtained from a wavelength of 587.56 mm, the solid line indicates tangential astigmatic aberration, and the dotted line indicates saggital astigmatic aberration.

In FIG. 2B, a difference between the solid line and the dotted line indicates astigmatic aberration, and a curved extent of the solid line indicates curvature of image field.

In FIG. 2B, the horizontal axis indicates astigmatic aberration or curvature of image field coefficient, and the vertical axis indicates distance from the center to the edge of an image falling on the image capture device 160. That is, the horizontal axis represents the deviation in mm units of the position of the focal point, and the vertical axis represents the image height in mm units.

In FIG. 2B, there is small change in each of astigmatic aberration from the center to the edge of the image and curvature in image field. From this, it is concluded that the astigmatic aberration and the curvature of image field occur slightly in the 3-dimensional photographing lens system 100 of FIG. 1.

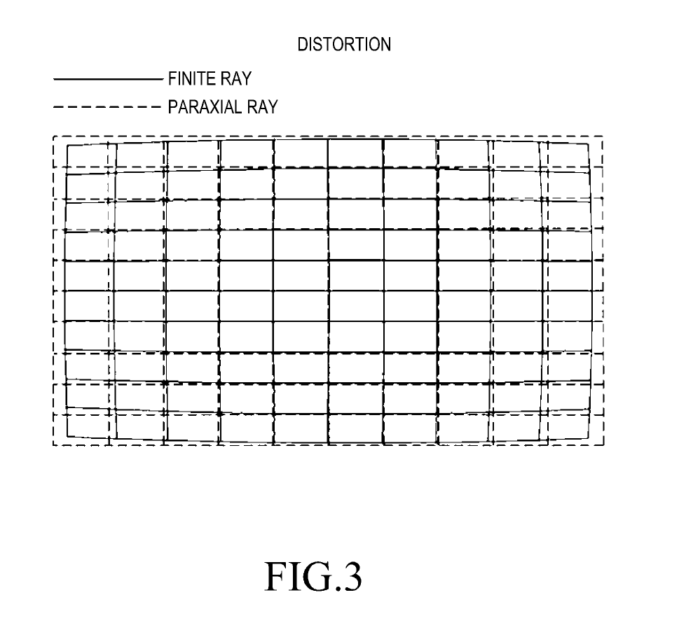

FIG. 3 illustrates distortion in the 3-dimensional photographing lens system 100 in accordance with the first embodiment.

The paraxial image is a distortion-free ideal image, and the finite image is a distorted real image.

Upon comparing the paraxial image and the finite image, there is negligible distortion in the central area in FIG. 3 but there is some distortion in the marginal area.

Although a still image is compensated in the distorted marginal area but a moving image is not compensated in the distorted marginal area, the degree of distortion is low to be included within a permissible range.

The slight distortion occurring in the marginal area is a phenomenon typically occurring when one or more lenses are used. However, since the degree of distortion is not so high, the distortion has little effect.

The finite image of FIG. 3 shows the shape of an image falling on the image capture device 160.

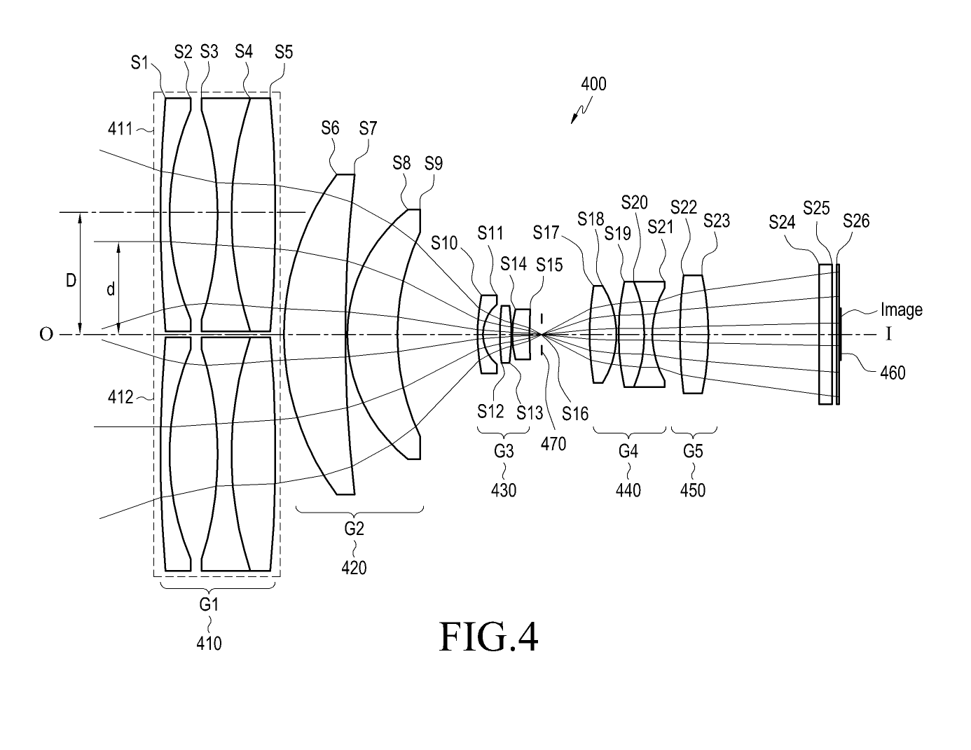

FIG. 4 illustrates a 3-dimensional photographing lens system in accordance with a second embodiment of the present invention.

Referring to FIG. 4, the inventive 3-dimensional photographing lens system 400 includes, in order from an object side O to an image side I, a first lens group G1, 410 having negative refractive power, a second lens group G2, 420 having positive refractive power, a third lens group G3, 430 having negative refractive power, a fourth lens group G4, 440 having positive refractive power, and a fifth lens group G5, 450 having positive refractive power.

In addition, the 3-dimensional photographing lens system 400 includes an iris 470. It is possible to tune the amount of beams falling on an image capture device 460 by tuning the size of the iris 470.

The 3-dimensional photographing lens system 400 of FIG. 4 has the same configuration with the 3-dimensional photographing lens system 100 of FIG. 1.

The individual lens groups 410, 420, 430, 440 and 450 of FIG. 4 perform the same functions with the individual lens groups 110, 120, 130, 140 and 150 of FIG. 1, and the iris 470 and the image capture device 460 also perform the same functions with the iris 170 and the image capture device 160 of FIG. 1.

The second embodiment to be described below is the same with the first embodiment except the data for individual lenses. That is, the functions of the entire lens system, i.e. the 3-dimensional photographing lens system 400 are the same with those of the 3-dimensional photographing lens system 100 of FIG. 1.

### Second Embodiment

FIG. 4 is depicted in accordance with the lens data of the second embodiment.

S1 to S23 indicate relevant lens surfaces, respectively, and S24 to S26 indicate relevant plates, respectively.

f=14.78, 2ω=42.25 degrees, and F-number=5.76

Table 3 shows numerical data of components constituting the 3-dimensional photographing lens system 400. In the numerical data, R denotes the radius of curvature of an i^{th} lens surface Si, D denotes the thickness of the i^{th} lens surface Si or an air gap (or a distance) between the i^{th} lens surface Si and an (i+1)^{th} lens surface S(i+1), Nd denotes a refractive index at the d-line (587.5618 nm) of the i^{th} lens surface Si, and vd denotes an Abbe number of the i^{th} lens surface Si, wherein a unit of the radius of curvature and the thickness is mm.

TABLE 3

| | R (Curvature Radius | D (Thick- | Nd (Refractive | νd |
|---|---|---|---|---|
| Object | of Lens Surface) | ness) | Index) | (Abbe No.) |
| S1 | 300.000 | 1.000 | 1.834001 | 37.35 |
| S2 | 36.035 | 5.382 | | |
| S3 | −49.995 | 2.653 | 1.804000 | 46.50 |
| S4 | 35.413 | 7.691 | 1.834960 | 24.30 |
| S5 | −169.363 | 0.600 | | |
| S6 | 39.560 | 7.908 | 1.770482 | 47.95 |
| S7 | 278.205 | 0.300 | | |
| S8 | 20.000 | 7.416 | 1.794510 | 39.66 |
| S9 | 37.069 | 8.437 | | |
| S10 | 35.903 | 1.000 | 1.846663 | 23.78 |
| S11 | 5.992 | 2.386 | | |
| S12 | 106.097 | 1.000 | 1.808743 | 24.89 |
| S13 | 24.162 | 0.300 | | |
| S14 | 19.569 | 2.227 | 1.834810 | 42.72 |
| S15 | 123.295 | 1.809 | | |
| S16 | ST | 6.389 | | |
| S17 | 143.000 | 4.046 | 1.693500 | 53.19 |
| S18 | −12.531 | 0.300 | | |
| S19 | 37.084 | 4.402 | 1.804000 | 46.50 |
| S20 | −17.376 | 1.500 | 1.645600 | 34.29 |
| S21 | 16.217 | 4.425 | | |
| S22 | 92.889 | 3.831 | 1.496997 | 81.61 |
| S23 | −47.175 | 19.617 | | |
| S24 | Infinity | 2.240 | 1.516798 | 64.20 |
| S25 | Infinity | 0.500 | | |
| S26 | Infinity | 0.700 | 1.516798 | 64.20 |
| Image | Infinity | 0.419 | | |

Coefficients of aspheric surfaces formed on S17 and S18 are indicated in Table 4.

TABLE 4

| Object | K | A | B | C |
|---|---|---|---|---|
| S17 | −1.000 | −4.919785E−06 | 9.321374E−08 | −7.628086E−10 |
| S18 | −0.353 | 2.161451E−05 | 2.684596E−07 | 4.532735E−10 |

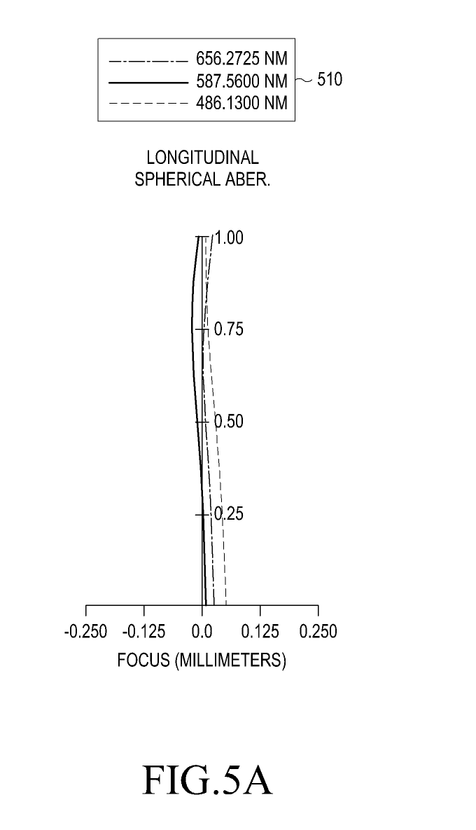

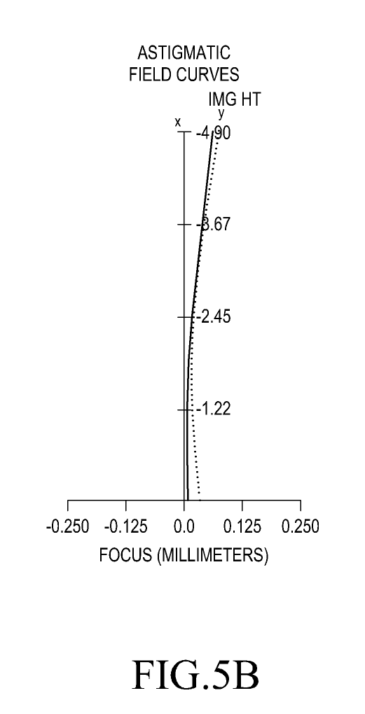

FIG. 5A illustrates a change in longitudinal spherical aberration of the lens system in accordance with the second embodiment.

As shown in FIG. 5A, the longitudinal spherical aberration data is variable as a wavelength changes.

In FIG. 5A, the horizontal axis indicates longitudinal spherical aberration coefficient, and the vertical axis indicates normalized distance to an edge of an image from the optical axis. That is, the horizontal axis represents the deviation in mm units of the position of the focal point, and the vertical axis represents an incidence height of light normalized by the maximum incidence height.

In FIG. 5A, even if the wavelength is changed as indicated in a box 510, there is small change in longitudinal spherical aberration. From this, it is concluded that the longitudinal spherical aberration occurs slightly in the 3-dimensional photographing lens system 400 of FIG. 4.

FIG. 5B illustrates astigmatic aberration and curvature of image field in the 3-dimensional photographing lens 400 in accordance with the third embodiment.

In FIG. 5B, the solid line indicates tangential astigmatic aberration, and the dotted line indicates saggital astigmatic aberration, data is shown indicating a change in astigmatic aberration and a change in curvature of image field, the horizontal axis indicates astigmatic aberration or curvature of image field coefficient, and the vertical axis indicates distance from the center to the edge of an image falling on the image capture device 460. That is, the horizontal axis represents the deviation in mm units of the position of the focal point, and the vertical axis represents the image height in mm units.

It can be seen that the distances of horizontal axes of FIG. 5B and FIG. 2B are different from each other.

Such a difference is caused due to the difference in size between the images falling on the image capture devices 460 and 160 in accordance with different designs of optical systems.

In FIG. 5B, there is small change in each of astigmatic aberration from the center to the edge of the image and curvature in image field. From this, it is concluded that the astigmatic aberration and the curvature of image field occur slightly in the 3-dimensional photographing lens system 400 of FIG. 4.

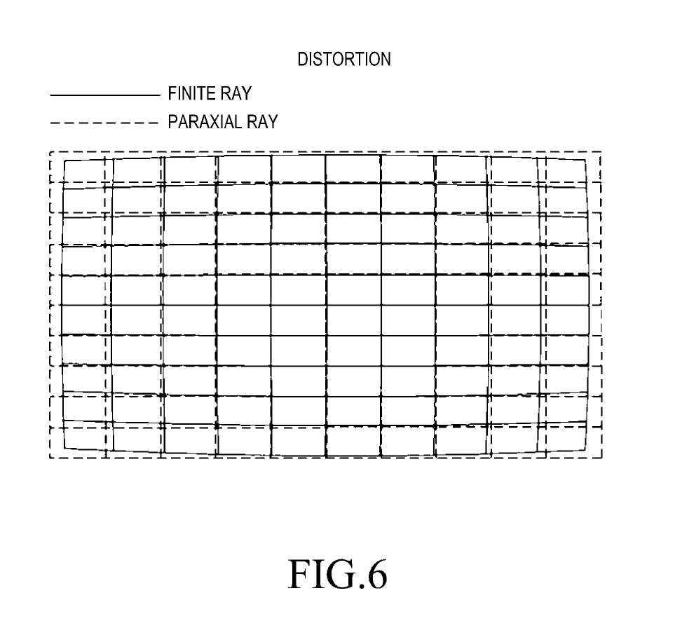

FIG. 6 illustrates distortion in the 3-dimensional photographing lens system 400 in accordance with the second embodiment.

The paraxial image is a distortion-free ideal image, and the finite image is a distorted real image.

Upon comparing the paraxial image and the finite image, there is negligible distortion in the central area in FIG. 6 but there is some distortion in the marginal area.

Although a still image is compensated in the distorted marginal area but a moving image is not compensated in the distorted marginal area, the degree of distortion is low to be included within a permissible range.

The slight distortion occurring in the marginal area is a phenomenon typically occurring when one or more lenses are used. However, since the degree of distortion is not so high, the distortion has little effect.

The finite image of FIG. 6 shows the shape of an image falling on the image capture device 460.

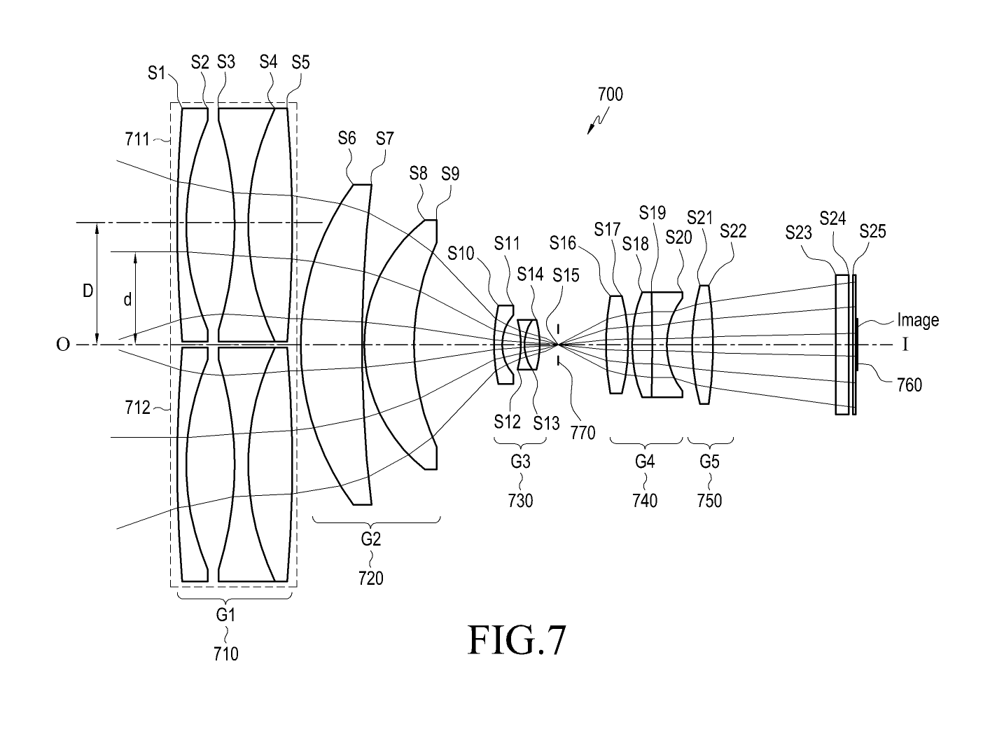

FIG. 7 illustrates a 3-dimensional photographing lens system in accordance with a third embodiment of the present invention.

Referring to FIG. 7, the inventive 3-dimensional photographing lens system 700 includes, in order from an object side O to an image side I, a first lens group G1, 710 having negative refractive power, a second lens group G2, 720 having positive refractive power, a third lens group G3, 730 having negative refractive power, a fourth lens group G4, 740 having positive refractive power, and a fifth lens group G5, 750 having positive refractive power.

In addition, the 3-dimensional photographing lens system 700 includes an iris 770. It is possible to tune the amount of beams falling on an image capture device 760 by tuning the size of the iris 770.

The third lens group 730 includes a concave lens and a cemented lens formed by cementing a concave lens and a convex lens. The cemented lens is formed from a material with a low Abbe number and a material with a high Abbe number to minimize the chromatic aberration thereof.

Similar to the photographing lens system of FIG. 4, the photographing lens system of FIG. 7 performs the same functions with the photographing lens system of FIG. 1. Therefore, the description of the functions is omitted.

### Third Embodiment

FIG. 7 is depicted in accordance with the lens data of the third embodiment.

S1 to S23 indicate relevant lens surfaces, respectively, and S24 to S26 indicate relevant plates, respectively.

f=14.734, 2ω=44 degrees, and F-number=5.3

Table 5 shows numerical data of components constituting the 3-dimensional photographing lens system 100. In the numerical data, R denotes the radius of curvature of an i^{th} lens surface Si, D denotes the thickness of the i^{th} lens surface Si or an air gap (or a distance) between the i^{th} lens surface Si and an (i+1)^{th}lens surface S(i+1), Nd denotes a refractive index at the d-line (587.5618 nm) of the i^{th} lens surface Si, and vd denotes an Abbe number of the i^{th} lens surface Si, wherein a unit of the radius of curvature and the thickness is mm.

TABLE 5

| | R (Curvature Radius | D (Thick- | Nd (Refractive | νd |
|---|---|---|---|---|
| Object | of Lens Surface) | ness) | Index) | (Abbe No.) |
| S1 | 300.000 | 1.500 | 1.834001 | 37.35 |
| S2 | 44.934 | 7.468 | | |
| S3 | −68.857 | 2.500 | 1.804200 | 46.50 |
| S4 | 43.562 | 6.500 | 1.846663 | 23.78 |
| S5 | −300.000 | 4.028 | | |
| S6 | 49.348 | 10.458 | 1.785897 | 43.93 |
| S7 | 300.000 | 0.700 | | |
| S8 | 28.352 | 8.000 | 1.834001 | 37.35 |
| S9 | 45.000 | 12.136 | | |
| S10 | 63.936 | 2.200 | 1.619881 | 37.55 |
| S11 | 7.856 | 5.184 | | |
| S12 | −24.483 | 1.000 | 1.766065 | 27.18 |
| S13 | 10.195 | 3.902 | 1.834810 | 42.72 |
| S14 | −23.797 | 5.516 | | |
| S15 | ST | 9.785 | | |
| S16 | 58.223 | 4.879 | 1.797770 | 43.30 |
| S17 | −31.526 | 0.938 | | |
| S18 | 29.800 | 3.371 | 1.804200 | 46.50 |
| S19 | −377.587 | 1.500 | 1.688930 | 31.16 |
| S20 | 16.778 | 4.465 | | |
| S21 | 33.491 | 3.971 | 1.496997 | 81.61 |
| S22 | −72.309 | 20.501 | | |
| S23 | Infinity | 2.240 | 1.516798 | 64.20 |
| S24 | Infinity | 0.500 | | |
| S25 | Infinity | 0.700 | 1.516798 | 64.20 |
| Image | Infinity | 0.399 | | |

Coefficients of aspheric surfaces formed on S17 and S18 are indicated in Table 6.

TABLE 6

| Object | K | A | B | C |
|---|---|---|---|---|
| S16 | 1.000 | 2.704479E−05 | 1.383854E−07 | −2.957080E−10 |
| S17 | −1.000 | 2.561467E−05 | 1.740859E−07 | 1.871212E−10 |

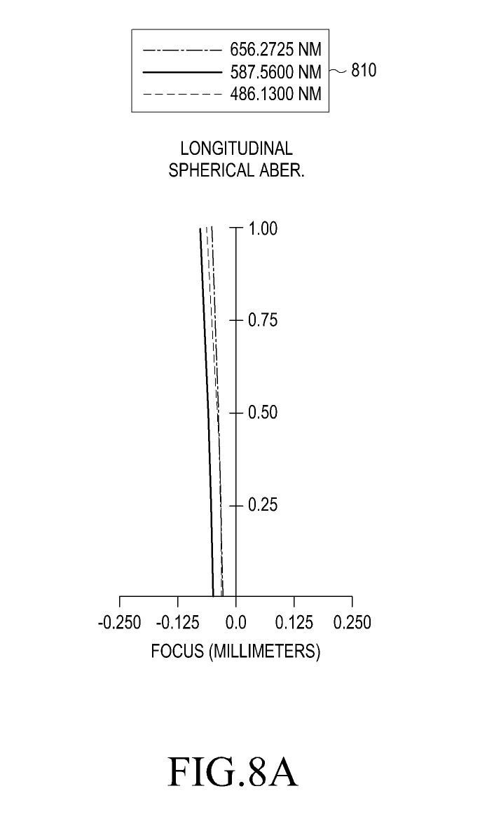

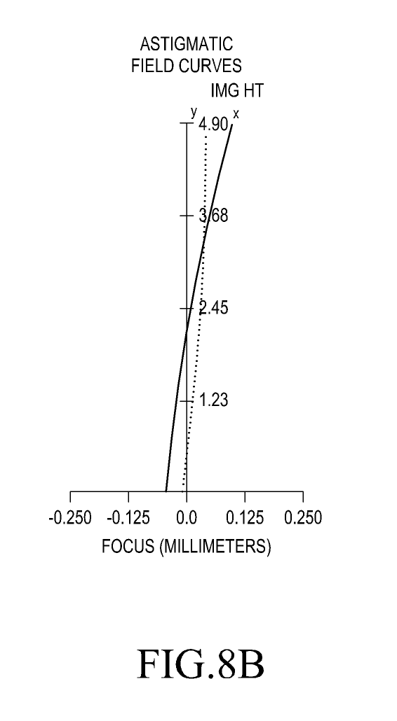

FIG. 8A illustrates a change in longitudinal spherical aberration of the lens system in accordance with the third embodiment.

As shown in FIG. 8A, the longitudinal spherical aberration data is variable as a wavelength changes.

In FIG. 8A, the horizontal axis indicates longitudinal spherical aberration coefficient, and the vertical axis indicates normalized distance to an edge of an image from the optical axis. That is, the horizontal axis represents the deviation in mm units of the position of the focal point, and the vertical axis represents an incidence height of light normalized by the maximum incidence height.

In FIG. 8A, even if the wavelength is changed as indicated in a box 810, there is a negligible change in longitudinal spherical aberration. From this, it is concluded that the longitudinal spherical aberration occurs slightly in the 3-dimensional photographing lens system 700 of FIG. 7.

FIG. 8B illustrates astigmatic aberration and curvature of image field in the 3-dimensional photographing lens 700 in accordance with the third embodiment.

In FIG. 8B, the solid line indicates tangential astigmatic aberration, and the dotted line indicates saggital astigmatic aberration, data is shown indicating a change in astigmatic aberration and a change in curvature of image field, the horizontal axis indicates astigmatic aberration or curvature of image field coefficient, and the vertical axis indicates distance from the center to the edge of an image falling on the image capture device 760. That is, the horizontal axis represents the deviation in mm units of the position of the focal point, and the vertical axis represents the image height in mm units.

In FIG. 8B, there is a negligible change in each of astigmatic aberration from the center to the edge of the image and curvature in image field. From this, it is concluded that the astigmatic aberration and the curvature of image field occur slightly in the 3-dimensional photographing lens system 700 of FIG. 4.

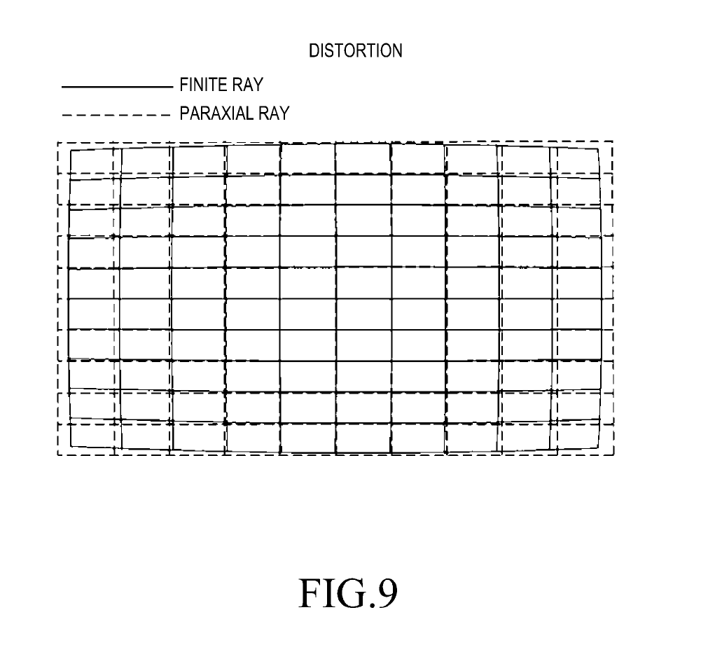

FIG. 9 illustrates distortion in the 3-dimensional photographing lens system 700 in accordance with the third embodiment.

The paraxial image is a distortion-free ideal image, and the finite image is a distorted real image.

Upon comparing the paraxial image and the finite image, there is negligible distortion in the central area in FIG. 9 but there is some distortion in the marginal area.

Although a still image is compensated in the distorted marginal area but a moving image is not compensated in the distorted marginal area, the degree of distortion is low to be included within a permissible range.

The slight distortion occurring in the marginal area is a phenomenon typically occurring when one or more lenses are used. However, since the degree of distortion is not so high, the distortion has little effect.

The finite image of FIG. 7 shows the shape of an image falling on the image capture device 760.

Table 7 shows f₃/f ratios among the data of the first to third embodiments.

In Table 7, the first embodiment is when f₃/f=0.88, and the third embodiment is when f₃/f=1.52. The difference in the f₃/f ratios is caused because the lens data and inter-lens distances applied to the embodiments are different from embodiment to embodiment.

Based on the results of FIGS. 2 and 3 in accordance with the first embodiment, aberrations are removed as in the results of FIGS. 5 and 6 in accordance with the third embodiment.

In addition, by resetting the f₃/f ratio to the minimum of 0.5 and to the maximum of 2.0, the same results with FIGS. 2 and 3 are obtained.

Based on this, the astigmatic aberration is corrected and the balance thereof is maintained in the 3-dimensional photographing lens systems 100, 400 and 700 even if the f₃/f ratio is from 0.5 to 2.0.

TABLE 7

| | First Embodiment | Second Embodiment | Third Embodiment |
|---|---|---|---|
| f₃/f | 0.88 | 0.65 | 1.52 |

Table 8 shows f₂/f₃ ratios among the data of the first to third embodiments.

In Table 7, the first embodiment is when f₂/f₃=3.15, and the third embodiment is when f₂/f₃=1.67. The difference in the f₂/f₃ ratios is caused because the lens data and inter-lens distances applied to the first to third embodiments are different from each other.

Based on the results of FIGS. 2 and 3 in accordance with the first embodiment, aberrations are removed as in the results of FIGS. 5 and 6 in accordance with the third embodiment.

In addition, by resetting the f₂/f₃ ratio to the minimum of 1.25 and to the maximum of 3.5, the same results with FIGS. 2 and 3 are obtained.

Based on this, the astigmatic aberration, spherical aberration and coma aberration are corrected, and the balance thereof is maintained in the 3-dimensional photographing lens systems 100, 400 and 700 even if the f₂/f₃ ratio is from 1.25 to 3.5.

TABLE 8

| | First Embodiment | Second embodiment | Third Embodiment |
|---|---|---|---|
| f₂/f₃ | 3.15 | 2.69 | 1.67 |

Table 9 shows f₄/f ratios among the data of the first to third embodiments.

In Table 9, the first embodiment is when f₄/f=1.38, and the third embodiment is when f₄/f₃=2.09. The difference in the f₄/f ratios is caused because the lens data and inter-lens distances applied to the first to third embodiments are different from each other.

Based on the results of FIGS. 2 and 3 in accordance with the first embodiment, aberrations are removed as in the results of FIGS. 5 and 6 in accordance with the third embodiment.

In addition, by resetting the f₄/f ratio to the minimum of 0.7 and to the maximum of 2.5, the same results with FIGS. 2 and 3 are obtained.

Based on this, spherical aberration and coma aberration are corrected, and the balance thereof is maintained in the 3-dimensional photographing lens systems 100, 400 and 700 even if the f₄/f ratio is from 0.7 to 2.5.

TABLE 9

| | First Embodiment | Second Embodiment | Third Embodiment |
|---|---|---|---|
| f₄/f | 1.38 | 1.12 | 2.09 |

Table 10 shows eccentric amounts (D) deviated from the optical axis, which are the distances from the left-eye lens or right-eye lens to the optical axis in Embodiments 1 to 3.

If the eccentric amounts are changed from the first to third embodiments, it can be appreciated that the data of lenses between the first lens group and the fifth lens group in each embodiment will be changed.

Referring to Table 10, it is possible to obtain the same results with FIGS. 2 and 3, FIGS. 5 and 6 and FIGS. 8 and 9, even if the eccentric amounts are changed in the 3-dimensional photographing lens system 100, 400 and 700.

Even if the configurations of the lens systems are changed, the same results can be obtained.

TABLE 10

| | First Embodiment | Second Embodiment | Third Embodiment |
|---|---|---|---|
| D | 20.96 mm | 15.14 mm | 19.14 mm |

Table 11 shows inter-camera distances (2 d), which are eccentric amounts (D) deviated from the optical axis in Embodiments 1 to 3.

Referring to Table 10, when an eccentric amount is changed, the inter-camera distance, which is a distance between the left-eye lens and the right-eye lens, is also changed in the same direction.

For example, if the eccentric amount increases, the inter-camera distance also increases, and if the eccentric amount decreases, the inter-camera distance also decreases.

From the first to third Embodiments, when the inter-camera distance is changed, the data of lenses positioned between the first lens group and the fifth lens group are also changed.

Referring to Table 11, the same results with FIGS. 2 and 3, FIGS. 5 and 6 and FIGS. 8 and 9 are obtained, even if the eccentric amounts are changed in the 3-dimensional photographing lens system 100, 400 and 700.

Even if the configurations of the lens systems are changed, the same results can be obtained.

TABLE 11

| | First Embodiment | Second Embodiment | Third Embodiment |
|---|---|---|---|
| 2d | 32.74 mm | 24 mm | 31.68 mm |

The inter-camera distance (ICD) providing a cubic effect and the largest lens diameter in the 3-dimensional photographing lens rely on the size of the image capture device 160.

If a 3-dimensional photographing lens system is configured, and an image capture device of a predetermined size is determined, the sizes of lenses are determined in such a manner that no image escapes the image capture device. In addition, the inter-camera distance is also determined in such a manner that left-eye and right-eye images fall on the image capture device of the predetermined size without escaping the image capture device.

The horizontal direction indicates a direction vertical to the optical axis direction (O-I). That is, the horizontal direction extends through the left-eye lens group 111 and the right-eye lens group 112.

Due to the limitation of the size of the image capture device 160 in fabricating a lens with a large diameter, the maximum value of the inter-camera distance is limited, making it difficult to obtain a 3-dimensional image with a preferable cubic effect.

Through the first to third Embodiments of the present invention, it is possible to configure a 3-dimensional photographing lens system as defined in Table 5, which allows the inter-camera distance to be at least 30 mm, and to obtain a 3-dimensional image with a preferable cubic effect.

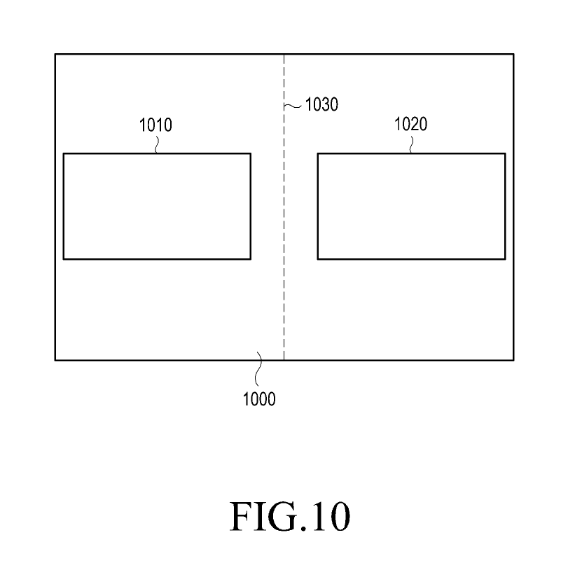

FIG. 10 illustrates an image capture device 1000 in accordance with another embodiment of the present invention.

The image capture device 100 corresponds to each of the image capture devices 160, 460 and 760 in FIGS. 1, 4 and 7.

The image capture device 100 includes a left-eye image falling region 1010 and a right-eye image falling region 1020.

About the reference line 1030, the left-eye region 1010 is positioned on the left side, and the right-eye region 1020 is positioned on the right side.

The sizes of the left-eye region 1010 and the right-eye region 102 is varied depending on the entire focal length and field of view of the 3-dimensional photographing lens system.

In a 3-dimensional image, there exists a distance at which no depth impression exists between left-eye and right-eye images, i.e., a visual disparity corresponds to zero (0), in which the phenomenon that the disparity corresponds to zero is referred to as convergence.

When convergence was already adjusted with reference to a predetermined distance, if an object positioned at a distance different from the predetermined distance is photographed, the cubic effect for the object becomes excessive, thereby increasing eye fatigue.

In order to reduce the eye fatigue, the convergence shall be adjusted toward the object.

Methods for adjusting the convergence include rotating a lens and differentiating image acquisition regions on an image capture device, in which the latter is simpler for adjusting the convergence.

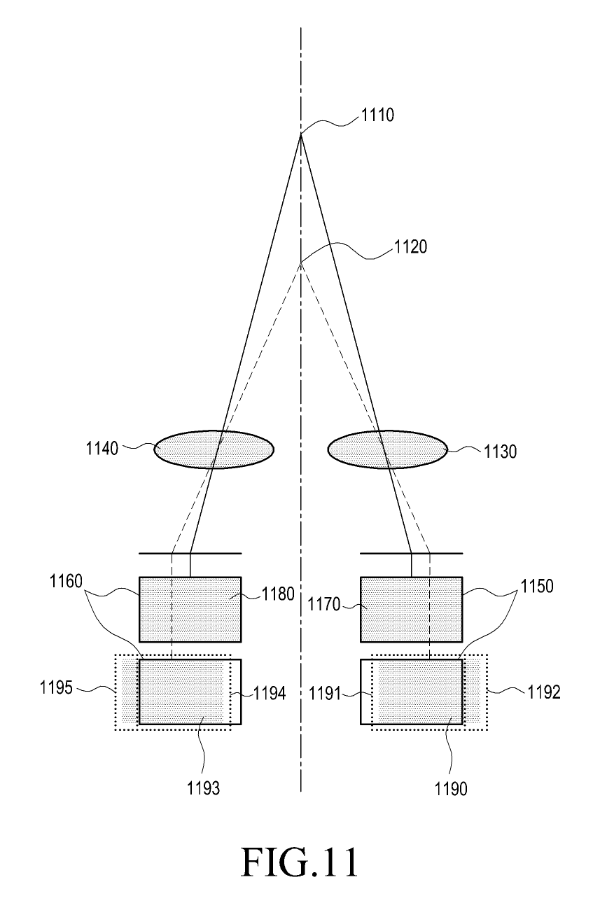

The method of differentiating image acquisition regions has a problem in that a part of images is lost when the image acquisition regions are differentiated. This is evident in FIG. 11.

FIG. 11 illustrates images falling on two image capture devices which are generally used, in which the image capture device for a left-eye image, and the image capture device for a right-eye image are configured to be different from each other.

Referring to FIG. 11, a partial loss of an image occurs when an image capture device has a size equal to that of the image falling thereon or does not have an extra space.

When an object 1110 positioned far away from a 3-dimensional lens system 100 is photographed by the 3-dimensional photographing lens system 100, a left-eye image 1170 passing through the left eye lens group 1130 will fall on a left-eye image capture device 1150.

Likewise, a right-eye image 1180 passing through the right-eye lens group 1140 will fall on a right-eye image capture device 1160.

When an image of an object 1120 positioned close to the 3-dimensional photographing lens system 100 is captured by the 3-dimensional photographing lens system 100, a left-eye image 1190 passing through the left lens group 1130 will fall on the left-eye image capture device 1150.

Likewise, a right-eye image 1193 passing through the right lens group 1140 will fall on the left-eye image capture device 1160.

When an image of the closely positioned object 1120 is captured by the 3-dimensional photographing lens 100, the left-eye image 1190 is formed in excess of the left-eye image capture device 1150. Therefore, only the left-eye image 1191 formed on the left-eye capture device 1150 is used, and the left-eye image 1192 formed beyond the left-eye capture device 1150 is not used.

Likewise, the right-eye image 1193 is formed in excess of the right-eye image capture device 1160. Therefore, only the right-eye image 119 formed on the right-eye capture device 1160 is used, and the right-eye image 1195 formed beyond the right-eye capture device 1160 is not used.

Referring to FIG. 11, since only the images formed on the left-eye image capture device 1150 and the right-eye image captured device 1160 are used for a 3-dimensional image, the images are partially lost.

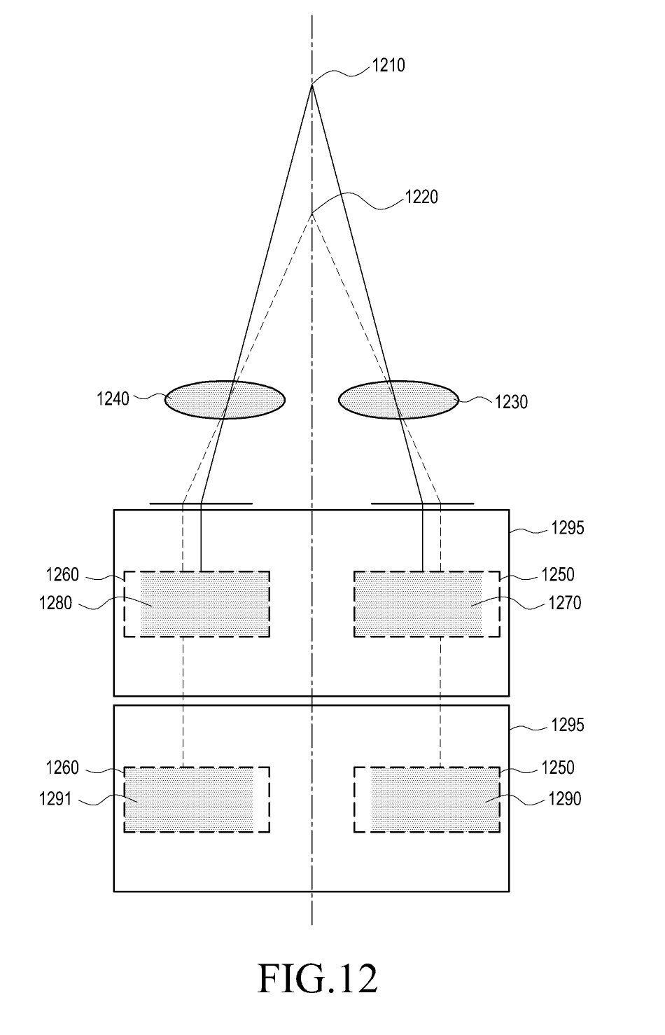

FIG. 12 illustrates an example of images falling on the image capture device according to the present invention.

In FIG. 12, a left-eye image falling region and a right-image falling region are formed on a single image capture device.

Referring to FIG. 12, when an object 1210 positioned at a long distance from the 3-dimensional photographing lens system photographs is captured by the 3-dimensional photographing lens system photographs, a left-eye image 1270 passing through the left-eye lens group 1230 will fall on the left-eye region 1250 of the image capture device.

Likewise, a right-eye image 1280 passing through the left-eye lens group 1240 will fall on the right-eye region 1260 of the image capture device.

When an object 1220 positioned at a short distance from the 3-dimensional photographing lens system 100 is photographed by the 3-dimensional photographing lens system, a left-eye image 1290 passing through the left-eye lens group 1230 will fall on the left-eye region 1250 of the image capture device.

Likewise, a right-eye image 1291 passing through the right-eye lens group 1240 will fall on the right-eye region 1260 of the image capture device.

The image capture device 1295 includes the left-eye region 1250 and the right-eye region 1260.

Since the present embodiment uses a region larger than a 3-dimensional image falling on the image-capture device 1295 as a 3-dimensional image capture region, the loss of the image is prevented.

The present embodiment designs the size of the image capture device 160 to be larger than images falling thereon by adjusting the convergence of the images, thereby preventing loss of the images.

The left-eye region 1250 and the right-eye region 1260 of the image capture device can be used in unison when capturing a 3-dimensional image, and any of the left-eye region 1250 and the right-eye region 1260 can be used when capturing a 2-dimensional image.

Through the embodiment shown in FIG. 12, it is possible to solve the problem of partial loss of an image by differentiating image capture regions.

Although FIG. 12 employs an image capture device 1295 extending in the direction parallel to a virtual straight line extending through the left-eye lens group and the right-eye lens group, it is possible to employ an image capture device extending in a direction nonparallel to the virtual straight line extending through the left-eye lens group and the right-eye lens group.

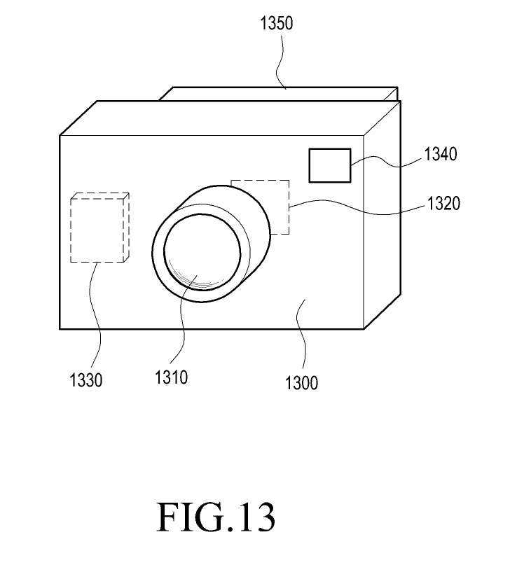

FIG. 13 illustrates a photographing apparatus 1300 with the inventive 3-dimensional photographing lens system 100. The photographing apparatus 1300 includes a 3-dimensional photographing lens system 1310 as described above, and an imaging device 1320 for receiving an image formed by the 3-dimensional photographing lens system 1310. The photographing apparatus 1300 may include a recording means 1330 recorded with information corresponding to an object image photo-electrically converted by the imaging device 1320, and a view finder 1340 for observing the object image.

The photographing apparatus may include a display unit 1350 for displaying the object image. Although FIG. 13 shows the view finder 1340 and the display unit 1350 separately provided in the photographing apparatus 1300, the photographing apparatus 1300 may include only the display unit without a separate view finder.

The photographing apparatus 1300 shown in FIG. 13 is merely an example, and the present invention is not limited thereto but rather applicable to various optical appliances.

As described above, the inventive 3-dimensional photographing lens system 100, 400 or 700 is lightened and miniaturized.

The inventive 3-dimensional photographing system 100, 400 or 700 has an excellent performance and makes it possible to easily obtain a preferable 3-dimensional image of a still image and a moving image with a relatively wide view of image field. In addition, the inventive 3-dimensional photographing apparatus can photograph portraits or landscapes at a substantially infinite distance as well as at a short distance.

In accordance with the present invention, there is provided a 3-dimensional photographing lens system adapted to remove aberrations occurring when a left-eye image passing through a left-eye lens group and a right-eye image passing through a right-eye lens group are off-axially incident to the lens system.

In accordance with the present invention, there is also provided an image capture apparatus having an image capture device designed to be larger than an image in order to prevent the loss of the image.

While the invention has been shown and described with reference to certain embodiments thereof, it will be understood by those skilled in the art that various changes in form and details is made therein without departing from the spirit and scope of the invention as defined by the appended claims.

What is claimed is:

1. A 3-dimensional photographing lens system comprising, in order from an object side to an image side:
a first lens group including a left-eye lens group with negative refractive power and a right-eye lens group with negative refractive power, the left eye lens group and the right-eye lens group being spaced apart from an optical axis left and right by a distance in parallel to the optical axis;
a second lens group with positive refractive power, the second lens group including at least one convex lens; and
a third lens group with negative refractive power, the third lens group including at least one concave lens, the 3-dimensional photographing lens system satisfying a requirement defined by
1.25<f₂/f₃<3.5,
wherein f₂ is a focal length of the second lens group, and f₃ is a focal length of the third lens group.

2. The 3-dimensional photographing lens system as claimed in claim 1, wherein the second lens group comprises meniscus lenses each having positive refractive power 20 and a convex surface.

3. The 3-dimensional photographing lens system as claimed in claim 1, wherein the second lens group and the third lens group are spaced apart from each other by a distance.

4. The 3-dimensional lens system as claimed in claim 1, wherein the third lens group comprises a negative meniscus lens having a convex surface.

5. The lens system as claimed in claim 1, further comprising a fourth lens group with positive refractive power between the third lens group and the image side, the fourth lens group comprising at least one aspheric lens.

6. The 3-dimensional photographing lens system as claimed in claim 5, wherein the lens system satisfies a requirement defined by
0.7<f₄/f<2.5,
wherein f₄ is a focal length of the fourth lens group, and f is a focal length of the entire lens system when the lens system is focused on an object at an infinite distance.

7. The 3-dimensional photographing lens system as claimed in claim 5, wherein the fourth lens group further comprises a cemented lens of a convex lens and a concave lens.

8. The 3-dimensional photographing lens system as claimed in claim 5, further comprising a fifth lens group with positive refractive power arranged between the fourth lens group and the image side, the fifth lens group comprising at least one convex lens.

9. The 3-dimensional photographing lens system as claimed in claim 8, wherein the fifth lens group is movable along the optical axis and tunes the focusing of an image falling on the image side.

10. The 3-dimensional photographing lens system as claimed in claim 8, wherein the 3-dimensional photographing lens system satisfies a requirement defined by
0.5<f₃/f<2.0,
wherein f₃ is a focal length of the third lens group, and f is a focal length of the entire lens system focused on an object at an infinite distance.

11. A photographing apparatus comprising, in order from an object side to an image side:
a first lens group including a left-eye lens group with negative refractive power and a right-eye lens group with negative refractive power, the left-eye lens group and the right-eye lens group being spaced apart from an optical axis left and right by a distance in parallel to the optical axis;
a second lens group with positive refractive power, the second lens group including at least one convex lens;
a third lens group with negative refractive power, the third lens group including at least one concave lens; and
an image capture device for receiving an image which has passed through the lens groups.

12. The photographing apparatus as claimed in claim 11, wherein the image capture device is divided into a left-eye image falling region and a right-eye image falling region.

13. A photographing apparatus including a 3-dimensional photographing lens system as claimed in claim 1, the apparatus comprising:
an image capture device for receiving an image captured by the 3-dimensional photographing lens system, wherein the image capture device is divided into a left-eye image falling region and a right-eye image falling region.
